(19) United States
(12) Patent Application Publication
(10) Pub. No.: US 2023/0146010 A1
(43) Pub. Date: May 11, 2023

(54) VENTURI PUMP SYSTEM FOR A FUEL SENDING UNIT

(71) Applicant: S&BFilters, Inc., Fontana, CA (US)

(72) Inventors: Cayman Berry Carter, Newport Beach, CA (US); Reed Jay Torres, Plano, TX (US)

(21) Appl. No.: 17/454,010

(22) Filed: Nov. 8, 2021

(51) Int. Cl. F04F 5/10; F04F 5/44; F02M 37/02

(52) U.S. Cl. CPC F04F 5/10; F04F 5/44; F02M 37/025

(57) ABSTRACT

A fuel system for a vehicle comprising a fuel tank having a fuel tank reservoir. A lift pump is outside of the fuel tank and includes an inlet, and first and second outlets, with the inlet being configured to receive fuel from the fuel tank. The lift pump is configured to output fluid from the first outlet at a first prescribed pressure. A venturi pump is located within the fuel reservoir and defines a venturi pump reservoir. The venturi pump includes a venturi jet including a drive inlet configured to be fluidly connectable to the first outlet of the lift pump to receive fluid therefrom. A suction inlet is configured to be placeable in fluid communication with the fuel tank reservoir and to draw fluid from the fuel tank reservoir into the venturi pump reservoir in response to fluid flowing through the venturi jet at the first prescribed pressure.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a pump for a vehicle fuel circuit, and more specifically, to a venturi pump configured for placement in a fuel tank and operatively connectable to a lift pump located outside of the fuel tank.

### 2. Description of the Related Art

Many gas or diesel powered vehicles include a fuel circuit that circulates fuel from a main fuel tank to the engine. In many fuel circuits, the fuel is pumped out of the fuel tank via a lift pump and delivered to a fuel injection system, wherein the fuel is injected into the engine for consumption. For instance, lift pumps have found widespread adoption in modern diesel trucks to create a constant supply of low-pressure fuel for the diesel injection system. Any unused fuel may be returned to the fuel tank via a return line for later use. Many fuel tanks include a fuel sending bucket located within the fuel tank reservoir, from which the fuel is drawn by the lift pump.

A common issue associated with use of an aftermarket lift pump, particularly in diesel trucks, occurs when the suction side of the lift pump drains the fuel sending bucket in the fuel tank, which results in the lift pump drawing air instead of fuel. This issue, commonly referred to as the “quarter tank issue,” results in the diesel injection system of the truck not receiving the correct amount of fuel pressure needed to supply the engine. Consequently, the truck's engine may enter a reduced power mode or shut off due to fuel starvation. This issue may commonly occur when the fuel level is at or below a certain level, typically below one quarter of the fuel tank capacity.

To solve this quarter tank issue, fuel systems may utilize several methods to maintain the fuel level in the fuel sending bucket (also commonly referred to as the sending unit), such as check valves in the bottoms of the bucket to allow fuel to flow in when the bucket level is lower than the rest of the tank. Additionally, some fuel sending units have internal pumps to draw fuel from outside the bucket into the bucket, with such pumps typically exceeding the capabilities of a simple check valve. Existing internal pumps are typically powered by, or include, a lift pump located in the bucket itself. However, such pumps tend to be limited in their ability to connect with more powerful pumps to deliver more fuel to the injection system than the factory pumps.

Accordingly, there is a need in the art for a pump for a fuel sending bucket which can be used in connection with a more powerful pump, such as a lift pump located outside of a conventional fuel tank. Various aspects of the present disclosure address this particular need, as will be discussed in more detail below.

### BRIEF SUMMARY

In accordance with one embodiment of the present disclosure, there is provided a fuel system for a vehicle comprising a fuel tank defining a fuel tank reservoir therein. A lift pump is located outside of the fuel tank and is in fluid communication with the fuel tank reservoir. The lift pump includes a fluid inlet, a first fluid outlet, and a second fluid outlet, with the fluid inlet being configured to receive fuel from the fuel tank. The lift pump is configured to output fluid from the first fluid outlet at a first prescribed pressure. A venturi pump is located within the fuel reservoir and defines a venturi pump reservoir therein. The venturi pump includes a venturi jet including a drive inlet and a suction inlet. The drive inlet is configured to be fluidly connectable to the first fluid outlet of the lift pump to receive fluid therefrom at the first prescribed pressure. The suction inlet is configured to be placeable in fluid communication with the fuel tank reservoir and to draw fluid from the fuel tank reservoir into the venturi pump reservoir in response to fluid flowing through the venturi jet at the first prescribed pressure.

The fuel system may additionally include a lift pump suction line extending from the venturi pump reservoir to the fluid inlet of the lift pump, with at least a portion of the lift pump suction line extending outside of the fuel tank.

The venturi jet may be configured to generate a fluid flow through the suction inlet of 4-5 gallons per hour in response to fluid flowing through the venturi jet at the first prescribed pressure.

The venturi jet may include a jet outlet in fluid communication with the venturi pump reservoir.

The venturi pump may include a housing having an upper wall, a lower wall, and a sidewall extending between the upper wall and the lower wall, with the housing defining the venturi pump reservoir. The upper wall may include a pair of inlet openings formed therein, the venturi housing further including a pair of ramps positioned with respect to respective ones of the pair of inlet openings such that fluid entering the pair of inlet openings impinges on respective one of the pair of ramps.

The venturi housing may further include a rigid tube coupled to the upper wall and extending toward the lower wall. The rigid tube may include a terminal edge adjacent the lower wall, with the venturi housing further including at least one finger extending from the rigid tube, the at least one finger being configured to space the terminal edge from the lower wall.

The venturi pump may include a one-way valve formed therein.

According to another embodiment, there is provided a venturi pump for a fuel circulation system in a vehicle, with the fuel circulation system including a fuel tank having a fuel tank reservoir. The fuel circulation system additionally includes a lift pump having a first fluid outlet, with the lift pump being configured to output fuel from the first fluid outlet at a first prescribed pressure. The venturi pump includes a housing sized to be disposable in the fuel tank reservoir, with the housing having an upper wall, a lower wall, and a sidewall extending between the upper wall and the lower wall. The housing defines a venturi pump reservoir. A venturi jet is coupled to the housing and includes a drive inlet and a suction inlet. The drive inlet is configured to be fluidly connectable to the first fluid outlet of the lift pump to receive fluid therefrom at the first prescribed pressure. The suction inlet is configured to be placeable in fluid communication with the fuel tank reservoir and to draw fluid from the fuel tank reservoir into the venturi pump reservoir in response to fluid flowing through the venturi jet at the first prescribed pressure. The venturi pump additionally includes a rigid tube coupled to the upper wall and extending toward the lower wall wherein the rigid tube includes a terminal edge adjacent the lower wall. At least one finger extends from the rigid tube and is configured to space the terminal edge from the lower wall.

According to yet another embodiment, there is provided a method of circulating fuel through a fuel circuit in a vehicle. The method includes urging fuel from a fuel tank reservoir of a fuel tank to a lift pump located outside of the fuel tank; outputting fuel from the lift pump via a first fluid outlet, the lift pump being configured to output fuel from the first fluid outlet at a first prescribed pressure; receiving fuel output from the first fluid outlet at a venturi pump, the received fuel being at the first prescribed pressure, the venturi pump having a venturi pump reservoir and a venturi jet; and allowing the received fuel to flow through the venturi jet, with the venturi jet being configured to generate a force which draws fuel from the fuel tank reservoir into the venturi pump reservoir in response to the received fuel flowing through the venturi jet.

The urging step may include causing fuel to flow through a lift pump suction line extending from the venturi pump reservoir to the fluid inlet of the lift pump, with at least a portion of the lift pump suction line extending outside of the fuel tank.

The method may also include the step of drawing fuel from the fuel tank reservoir into the venturi pump reservoir at a rate of 4-5 gallons per hour in response to fuel flowing through the venturi jet.

The method may further include the step of outputting fuel from the lift pump via a second fluid outlet. The fuel output from the second fluid outlet may be received at the venturi pump reservoir.

The urging step may include urging fuel from the venturi pump reservoir, with the venturi pump reservoir being located within the fuel pump reservoir. The urging step may include drawing fuel in the venturi pump reservoir via a rigid tube extending into the venturi pump reservoir.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic view of fuel system for circulating fuel within a vehicle, the fuel system including a venturi pump located within a fuel tank and in communication with a lift pump positioned outside of the fuel tank;

FIG. 2 is an upper perspective view of a venturi pump used in the fuel system of FIG. 1;

FIG. 3 is an upper perspective view of a connection plate included in the venturi pump of FIG. 2;

FIG. 4 is a lower perspective view of the connection plate depicted in FIG. 3;

FIG. 5 is an upper perspective view of a main unit included in the venturi pump of FIG. 2;

FIG. 6 is a lower perspective view of an upper wall of the main unit and a rigid tube connected to the upper wall;

FIG. 7 is an upper perspective view of a lower portion of the main unit, including a venturi jet extending into a venturi pump reservoir;

FIG. 8 is a top view of the lower portion of the main unit depicted in FIG. 7;

FIG. 9 is a bottom view of the main unit;

FIG. 10 is a partial upper perspective, sectional view of the lower portion of the main unit; and

FIG. 11 is a partial side sectional view of the lower portion of the main unit.

Common reference numerals are used throughout the drawings and the detailed description to indicate the same elements.

### DETAILED DESCRIPTION

The detailed description set forth below in connection with the appended drawings is intended as a description of certain embodiments of a venturi pump for a vehicle fuel circuit and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure are directed toward a venturi pump for use in a vehicle fuel circuit. The venturi pump is configured to be placed in a fuel tank of the and may defines a venturi pump reservoir, which may be filled by a venturi jet within the venturi pump. The venturi jet may draw in fuel from the larger fuel tank to fill the smaller venturi pump reservoir for purposes of providing an easier supply of fuel from which fuel may be drawn to supply to the engine, particularly as the fuel level in the fuel tank is low, e.g., below one-quarter of a tank. The venturi pump may be in fluid communication with a lift pump located outside of the fuel tank. The venturi pump receives fluid from an engine supply line, which is supplied by the lift pump at a generally consistent pressure. The consistent pressure allows for calculation and design of a preferred orifice size of the venturi jet to maintain a desired flow rate through the venturi pump to fill the venturi pump reservoir.

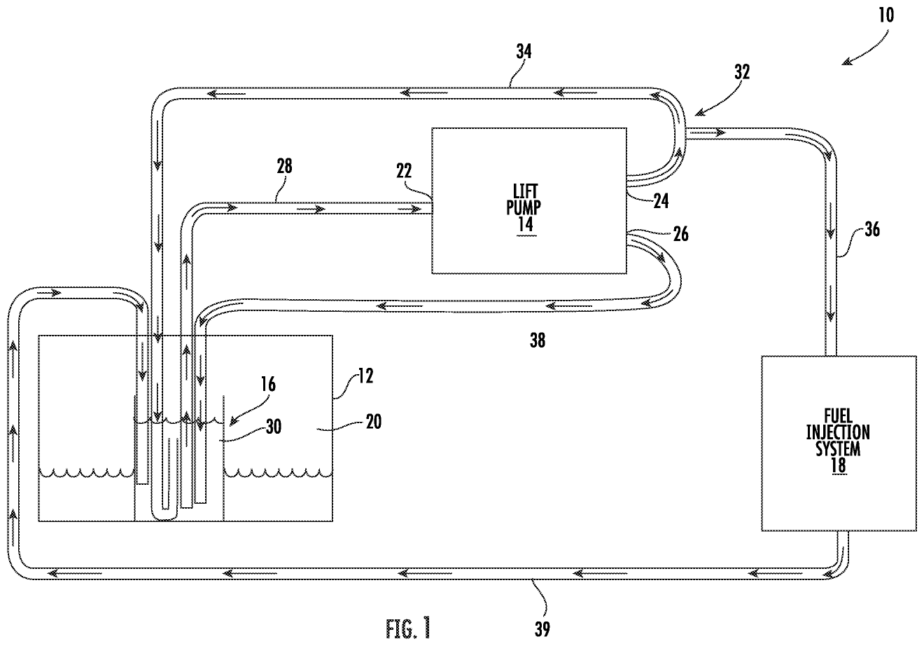

According to one embodiment and referring now specifically to the schematic diagram depicted in FIG. 1, a fuel system 10 for a vehicle includes a fuel tank 12, a lift pump 14, a venturi pump 16, and a fuel injection system 18, which may include a high-pressure fuel pump or hydraulically actuated fuel injectors. The fuel system 10 additionally includes several fluid lines (e.g., tubes, conduits, hoses, etc.) to facilitate transfer of fuel from one component to another.

The fuel tank 12 includes a fuel tank reservoir 20 sized and configured to receive vehicle fuel. The fuel tank reservoir 20 may be available in several sizes, such as between 10-30 gallons, depending on the size of the associated vehicle. It is contemplated that the size of the fuel tank reservoir 20 may be less than 10 gallons or greater than 30 gallons without departing from the spirit and scope of the present disclosure.

The lift pump 14 is located outside of the fuel tank 12 and is in fluid communication with the fuel tank reservoir 20. The lift pump 14 may be configured to create a constant supply of low-pressure fuel for a fuel injection system 18. According to one embodiment, the lift pump 14 includes a fluid inlet 22, a first fluid outlet 24, and a second fluid outlet 26. The fluid inlet 22 is connected to fluid line 28 which extends to the fuel tank 12, and in particular, to a venturi pump reservoir 30 located within the fuel tank 12, to supply fuel from the venturi pump reservoir 30 to the lift pump 14. The lift pump 14 may be configured to output fluid from the first fluid outlet 24 at a first prescribed pressure, desirable for the fuel injection system. In some vehicles, the first prescribed pressure may be between 50-60 PSI, although it is contemplated that the first prescribed pressure may be less than 50 PSI or greater than 60 PSI without departing from the spirit and scope of the present disclosure. The first fluid outlet 24 may be connected to an engine supply line 32 having a venturi supply branch 34 extending to the venturi pump 16 and a fuel injection branch 36 extending to the fuel injection system 18. The fluid in both the venturi supply branch 34 and the fuel injection branch 36 may be at the first prescribed pressure. The second fluid outlet 26 may be an excess outlet, to return any excess fuel not exiting via the first fluid outlet 24 to the fuel tank 12, and more specifically, to the venturi pump reservoir 30 via a lift pump return line 38. An engine return line 39 extend between the engine/fuel injection system 18 and the venturi pump 16 to return unused fuel from the engine to the venturi pump 16. Since the lift pump return line 38 and engine return line 39 may return excess fuel from the lift pump 14 and engine, respectively, the amount of fuel flowing through the lift pump return line 38 and engine return line 39 may vary during operation of the vehicle.

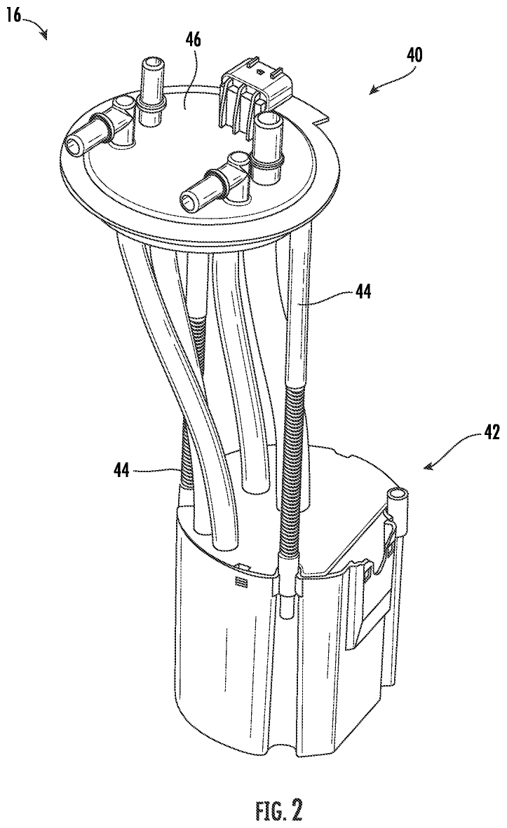

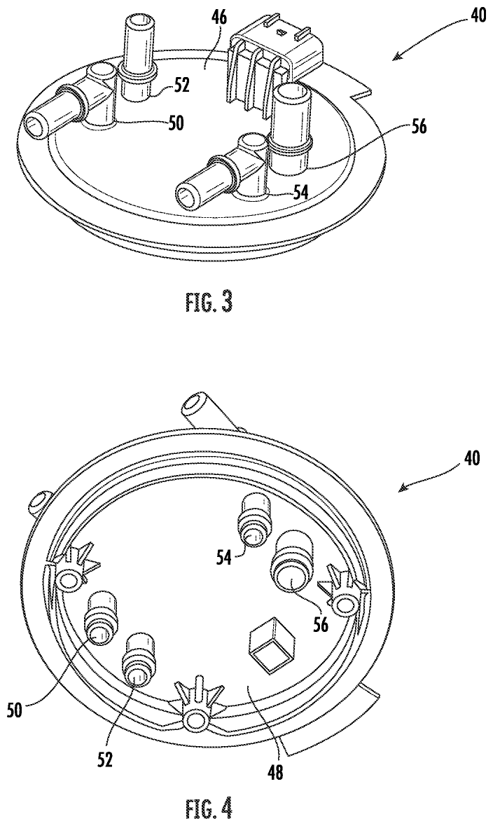

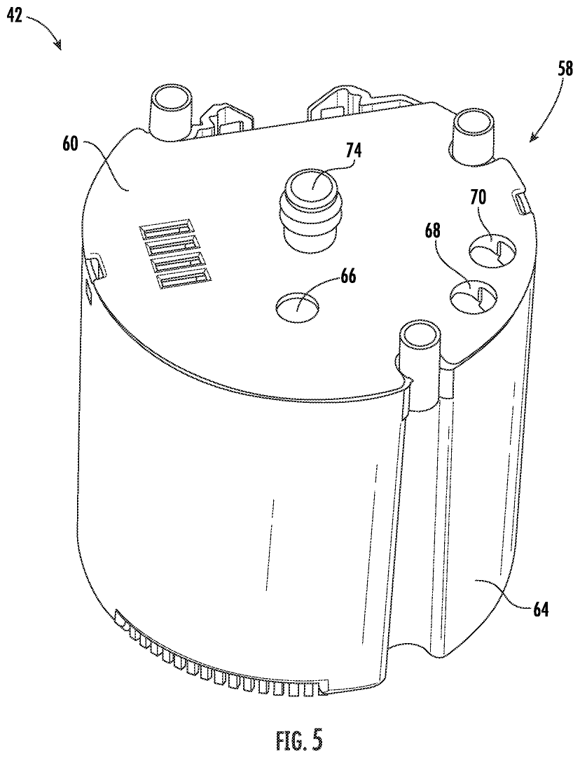

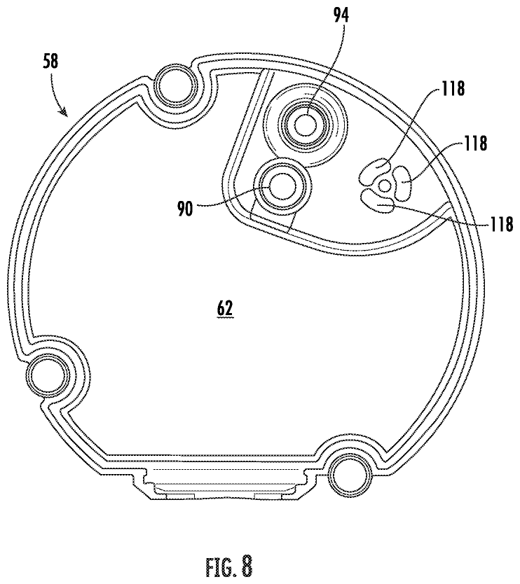

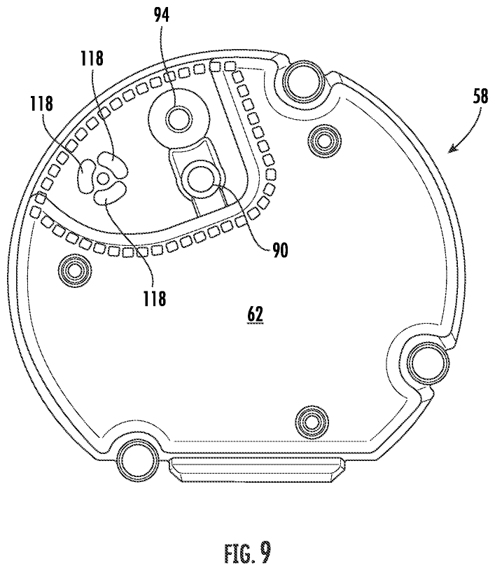

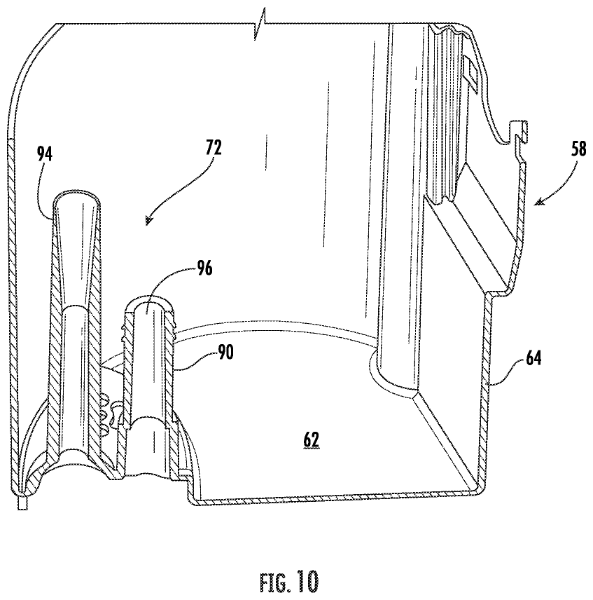

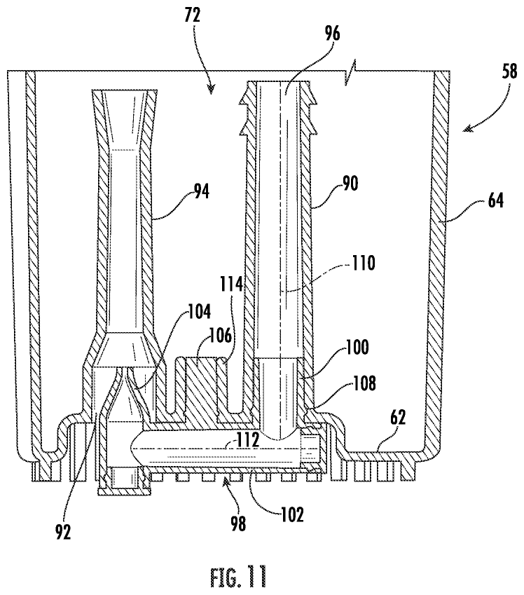

The venturi pump 16 is located within the fuel tank reservoir 20 and is disposable in fluid communication with the lift pump 14. FIGS. 2-11 show various views of an exemplary venturi pump 16, with FIG. 2 being an upper perspective view of the venturi pump 16, which may include a connection plate 40 and a main unit 42 connected to the connection plate 40 via one or more mechanical connections, as well as via one or more fluid connections. The mechanical connections may include one or more rigid shafts 44 extending between the connection plate 40 and the main unit 42. The rigid shafts 44 may include a threaded portion, which allows for positional adjustment of one or both of the connection plate 40 and main unit 42 along the rigid shafts 44. In the exemplary embodiment, the threaded portion of the rigid shafts 44 are connected to the main unit 42, such that rotation of the rigid shaft 44 relative to the main unit 42 in a first rotational direction causes the main unit 42 to move away from the connection plate 40, and rotation of the rigid shaft 44 relative to the main unit 42 in a second rotation direction causes the main unit 42 to move toward the connection plate 40.

The connection plate 40 may include an upper surface 46, an opposing lower surface 48, and a plurality of openings extending through the upper and lower surfaces 46, 48. Each opening may include a fitting extending from the upper and lower surfaces 46, 48 to facilitate attachment to a respective fluid line. In particular, the connection plate 40 may include three inlet openings, and one outlet opening. A first inlet opening 50 may be placed in communication with the engine return line 39 to receive unused fluid from the engine/fuel injection system 18. A second inlet opening 52 may be placeable in communication with the second fluid outlet 26 of the lift pump 14 to receive fuel via the lift pump return line 38. A third inlet opening 54 may be in communication with the first fluid outlet 24 of the lift pump 14 to receive fuel therefrom via the venturi supply branch 34 of the engine supply line 32. Outlet opening 56 may be placed in fluid communication with the lift pump 14 to supply fuel thereto.

The main unit 42 includes a housing 58 having an upper wall 60, a lower wall 62, and a sidewall 64 extending between the upper wall 60 and the lower wall 62, with the housing 58 defining the venturi pump reservoir 30. The upper wall 60 may include three inlet openings 66, 68, 70 formed therein to receive fluid from respective ones of the first, second, and third inlet openings 50, 52, 54 of the connection plate 40. In particular, inlet opening 66 receives fluid from the third inlet opening 54 to receive the pressurized fluid output from the lift pump 14 via the venturi supply branch 34 of the engine supply line 32. The inlet openings 68, 70 may receive fluid from the first and second inlet openings 50, 52, to receive fluid from the engine return line 39 and the lift pump return line 38. The housing 58 may additionally include an outlet opening 74, through which fluid may exit the housing 58 to flow to the lift pump 14, as will be described in more detail below.

A conduit may pass through, or be in communication with, the inlet opening 66 and connect with a venturi jet 72 to facilitate delivery of fuel under pressure to the venturi jet 72. The fuel received via the remaining two inlet openings 68, 70 may flow into the venturi pump reservoir 30 to fill the venturi pump reservoir 30. The venturi housing 58 may include a pair of ramps 76, 78 positioned with respect to respective ones of the inlet openings 68, 70 that receive fuel from the return lines 38, 39 such that fluid entering the pair of inlet openings 68, 70 from the return lines 38, 39 impinges on respective one of the pair of ramps 76, 78. The impingement of the fuel against the ramps 76, 78 after passing through the inlet openings 68, 70 may prevent or reduce the likelihood of bubbles forming the fuel.

The housing 58 may also include a pair of clips 80 connected to the upper wall 60 to facilitate detachable engagement of the upper wall 60 to the sidewall 64.

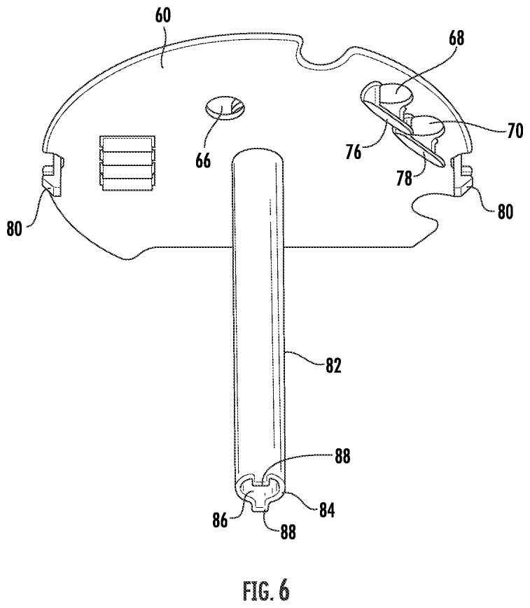

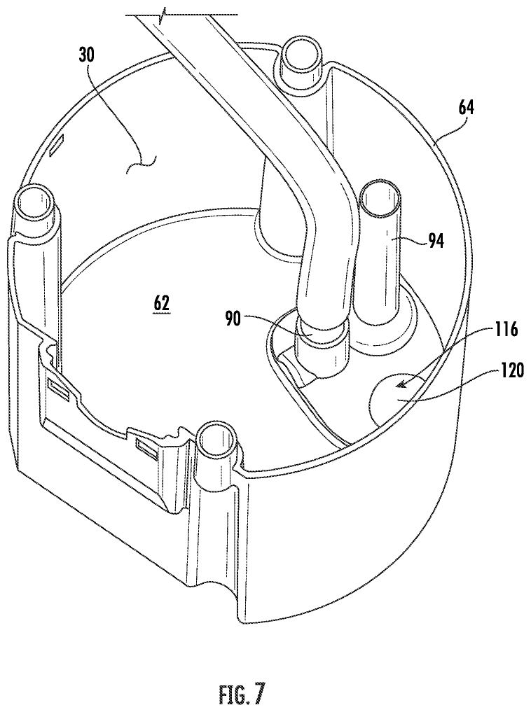

Referring now specifically to FIG. 6, the venturi housing 58 may further include a rigid tube 82 coupled to the upper wall 60 and extending toward the lower wall 62 when the upper wall 60 is attached to the sidewall 64. The rigid tube 82 may include a terminal edge 84 positionable adjacent the lower wall 62. The rigid tube 82 may form an internal passageway 86 within which fuel may be withdrawn from the venturi pump reservoir 30 to supply fuel to the lift pump 14. In the regard, operation of the lift pump 14 may produce a suction force within the internal passageway 86. The rigid tube 82 may have sufficient internal strength to prevent buckling or collapsing when the suction force is applied.

One or more fingers 88 may extend from the rigid tube 82, beyond the terminal edge 84, to contact the lower wall 62 and space the terminal edge 84 from the lower wall 62. In the exemplary embodiment, a pair of fingers 88 extend from the terminal edge 84 in diametrically opposed relation to each other, although the number, configuration, and placement of the fingers 88 is not limited thereto. The fingers 88 may be integrally formed with the rigid tube 82 or alternatively, formed separate from the rigid tube 82 and subsequently added onto the rigid tube 82. The space created between the terminal edge 84 and the lower wall 62 is the space through which fuel may flow from the venturi pump reservoir 30 and into the internal passageway of the rigid tube 82.

The venturi jet 72 may include a drive inlet 90, a suction inlet 92, and a jet outlet 94 in fluid communication with the venturi pump reservoir 30. The drive inlet 90 is configured to be fluidly connectable to the first fluid outlet 24 of the lift pump 14 via intervening conduits, such as the venturi supply branch 34, to receive fluid therefrom at the first prescribed pressure. The drive inlet 90 may be formed as a generally cylindrical wall having an internal passageway 96 formed therein. An outer surface of the drive inlet 90 may be barbed to facilitate connection to the conduit that delivers fuel from the lift pump 14.

The drive inlet 90 may be in communication with a connector body 98 that extends between the drive inlet 90 and the jet outlet 94. The connector body 98 may generally include an arm 100, a main portion 102, a nozzle portion 104 and a mounting post 106. The arm 100 is configured to extends into the drive inlet 90 to facilitate fluid-tight connection between the connector body 98 and the drive inlet 90. In the exemplary embodiment, the connector body 98 includes an outwardly extending protrusion or rib 108 that extends circumferentially around the arm 100 and is sized to be received in a corresponding groove formed on an inner surface of the drive inlet 90. The arm 100 includes an internal passageway that is in communication with the drive inlet 90 when the arm 100 is connected to the drive inlet 90.

The main portion 102 extends from the arm 100 in generally perpendicular relation thereto. In this regard, the internal passageway extending through the arm 100 extends along an arm axis 110 that is generally perpendicular to a main portion axis 112, along which an internal passageway of the main portion 102 extends.

The nozzle portion 104 is connected to main portion 102, opposite the arm 100, and defines an internal passageway having a tapered configuration terminating at a nozzle output. The nozzle portion 104 extends into a lower end portion of the jet outlet 94, such that the nozzle output is located within the jet outlet 94. The nozzle portion 104 and the jet outlet 94 are configured such that the suction inlet 92 (e.g., a gap) is formed therebetween. When the venturi pump 16 is placed within the fuel tank 12, the suction inlet 92 is in communication with the fuel tank reservoir 20. As such, fuel from the fuel tank reservoir 20 may pass through the suction inlet 92 and into the jet outlet 94 during operation of the venturi pump 16. The suction applied at the suction inlet 92 may be a result of the venturi effect associated with the flow of fuel through the constricted configuration of the nozzle outlet and into the jet outlet 94.

The mounting post 106 may be received within a mounting sleeve 114 formed on the housing 58 to facilitate connection between the connector body 98 and the housing 58.

The venturi pump 16 may include a one-way valve 116 formed therein. The one-way valve 116 may allow fluid to flow into the venturi pump reservoir 30 from the fuel tank reservoir 20 but may restrict fluid flow from the venturi pump reservoir 30 to the fuel tank reservoir 20. If the fuel level in the fuel tank reservoir 20 is greater than the fuel level in the venturi pump reservoir 30, the difference in fluid pressure due to the different fuel levels may urge the fluid in the fuel tank reservoir 20 to flow through the one-way valve 116 and into the venturi pump reservoir 30 until the levels are generally balanced. However, if the level of fuel in the venturi pump reservoir 30 is greater than the level of fuel in the fuel tank reservoir 20, the one-way valve 116 may prevent fuel from flowing out of the venturi pump reservoir 30. The one-way valve 116 may include a plurality of openings formed in the lower wall 62, which may be selectively covered or uncovered by a valve body (e.g., a butterfly valve) to either allow fluid flow through the openings, or block fluid flow through the openings.

The venturi jet 72 may be configured to generate a fluid flow through the suction inlet 92 of 4-5 gallons per hour in response to fluid flowing through the venturi jet 72 at the first prescribed pressure. However, the flow characteristics of the venturi jet 72 may be varied, e.g., less than 4 gallons or greater than 5 gallons, without departing from the spirit and scope of the present disclosure.

In operation, the lift pump 14 is actuated to draw fuel from the venturi pump reservoir 30 to the lift pump 14 via the lift pump suction line 28. The lift pump 14 outputs fuel at a generally constant pressure from the first outlet 24 to the engine supply line 32. Fuel flows at the elevated pressure along the fuel injection branch 36 to the fuel injection system 18, and the venturi supply branch 34 to the venturi pump 16. Any excess fuel, e.g., fuel not needed to flow to the fuel injection system 18, exits the second outlet 26 of the lift pump 14 along the lift pump return line 38. Likewise, any fuel not used by the fuel injection system 18 is returned to the venturi pump 16 via the engine return line 39.

At the venturi pump 16, fuel is received via the respective inlets, with the fuel received from the lift pump return line 38 and the engine return line 39 being flowing over the ramps 76, 78 to prevent bubbles from forming in the fuel.

The fuel received form the venturi supply branch 34 is received at an elevated pressure and is received at the jet inlet 90. The pressurized fuel flows through the jet inlet 90, through the arm 100 of the connector body 98, through the main portion 102 of the connector body 98, and then into the nozzle portion 104 of the connector body 98. The constricted passage in the nozzle portion 104 causes the fuel to flow at a greater speed as it exits the nozzle portion 104 to generate a venturi effect, and to impart a suction force on the suction inlet 92. The suction force causes fuel to enter the jet outlet 94 from the fuel tank reservoir 20 and join the fuel that has exited the nozzle portion 104 and flow through the jet outlet 94. As the fuel exits the jet outlet 94, the fuel enters the venturi pump reservoir 30.

The incorporation of the venturi pump 16 within the fuel tank reservoir 20 allows the level of fuel in the venturi pump reservoir 30 to remain at a level that is easier to draw from relative to the lower level of fuel in the fuel tank reservoir 20. The ability to keep an elevated fuel level in the venturi pump reservoir 30 is particularly beneficial when the level of fuel in the fuel tank 12 drops below a quarter of a tank and the fuel may slosh around the fuel tank 12 when the vehicle is turning or quickly changes speed.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A fuel system for a vehicle comprising:
a fuel tank defining a fuel tank reservoir therein;
a lift pump located outside of the fuel tank and in fluid communication with the fuel tank reservoir, the lift pump having a fluid inlet, a first fluid outlet, and a second fluid outlet, the fluid inlet being configured to receive fuel from the fuel tank, the lift pump being configured to output fluid from the first fluid outlet at a first prescribed pressure; and
a venturi pump located within the fuel reservoir and defining a venturi pump reservoir therein, the venturi pump having a venturi jet including a drive inlet and a suction inlet, the drive inlet being configured to be fluidly connectable to the first fluid outlet of the lift pump to receive fluid therefrom at the first prescribed pressure, the suction inlet being configured to be placeable in fluid communication with the fuel tank reservoir and to draw fluid from the fuel tank reservoir into the venturi pump reservoir in response to fluid flowing through the venturi jet at the first prescribed pressure.

2. The fuel system recited in claim 1, further comprising a lift pump suction line extending from the venturi pump reservoir to the fluid inlet of the lift pump, at least a portion of the lift pump suction line extending outside of the fuel tank.

3. The fuel system recited in claim 1, wherein the venturi jet is configured to generate a fluid flow through the suction inlet of 4-5 gallons per hour in response to fluid flowing through the venturi jet at the first prescribed pressure.

4. The fuel system recited in claim 1, wherein the venturi jet includes a jet outlet in fluid communication with the venturi pump reservoir.

5. The fuel system recited in claim 1, wherein the venturi pump includes a housing having an upper wall, a lower wall, and a sidewall extending between the upper wall and the lower wall, the housing defining the venturi pump reservoir.

6. The fuel system recited in claim 5, wherein the upper wall includes a pair of inlet openings formed therein, the venturi housing further including a pair of ramps positioned with respect to respective ones of the pair of inlet openings such that fluid entering the pair of inlet openings impinges on respective one of the pair of ramps.

7. The fuel system recited in claim 5, wherein the venturi housing further includes a rigid tube coupled to the upper wall and extending toward the lower wall.

8. The fuel system recited in claim 7, wherein the rigid tube includes a terminal edge adjacent the lower wall, the venturi housing further including at least one finger extending from the rigid tube, the at least one finger being configured to space the terminal edge from the lower wall.

9. The fuel system recited in claim 5, wherein the venturi pump includes a one-way valve formed therein.

10. A venturi pump for a fuel circulation system in a vehicle, the fuel circulation system including a fuel tank having a fuel tank reservoir, and a lift pump having a first fluid outlet, the lift pump being configured to output fuel from the first fluid outlet at a first prescribed pressure, the venturi pump comprising:
a housing sized to be disposable in the fuel tank reservoir, the housing having an upper wall, a lower wall, and a sidewall extending between the upper wall and the lower wall, the housing defining a venturi pump reservoir;
a venturi jet coupled to the housing and including a drive inlet and a suction inlet, the drive inlet being configured to be fluidly connectable to the first fluid outlet of the lift pump to receive fluid therefrom at the first prescribed pressure, the suction inlet being configured to be placeable in fluid communication with the fuel tank reservoir and to draw fluid from the fuel tank reservoir into the venturi pump reservoir in response to fluid flowing through the venturi jet at the first prescribed pressure;
a tube coupled to the upper wall and extending toward the lower wall wherein the tube includes a terminal edge adjacent the lower wall; and
at least one finger extending from the tube, the at least one finger being configured to space the terminal edge from the lower wall.

11. The venturi pump recited in claim 10, wherein the venturi jet is configured to generate a fluid flow through the suction inlet of 4-5 gallons per hour in response to fluid flowing through the venturi jet at the first prescribed pressure.

12. The venturi pump recited in claim 10, wherein the venturi jet includes a jet outlet in fluid communication with the venturi pump reservoir.

13. The venturi pump recited in claim 10, wherein the upper wall includes a pair of inlet openings formed therein, the venturi housing further including a pair of ramps positioned with respect to respective ones of the pair of inlet openings such that fluid entering the pair of inlet openings impinges on respective one of the pair of ramps.

14. A method of circulating fuel through a fuel circuit in a vehicle, the method comprising the steps of:
urging fuel from a fuel tank reservoir of a fuel tank to a lift pump located outside of the fuel tank;
outputting fuel from the lift pump via a first fluid outlet, the lift pump being configured to output fuel from the first fluid outlet at a first prescribed pressure;
receiving fuel output from the first fluid outlet at a venturi pump, the received fuel being at the first prescribed pressure, the venturi pump having a venturi pump reservoir and a venturi jet; and
allowing the received fuel to flow through the venturi jet, the venturi jet being configured to generate a force which draws fuel from the fuel tank reservoir into the venturi pump reservoir in response to the received fuel flowing through the venturi jet.

15. The method recited in claim 14, wherein the urging step includes causing fuel to flow through a lift pump suction line extending from the venturi pump reservoir to the fluid inlet of the lift pump, at least a portion of the lift pump suction line extending outside of the fuel tank.

16. The method recited in claim 14, further comprising the step of drawing fuel from the fuel tank reservoir into the venturi pump reservoir at a rate of 4-5 gallons per hour in response to fuel flowing through the venturi jet.

17. The method recited in claim 14, further comprising the step of outputting fuel from the lift pump via a second fluid outlet.

18. The method recited in claim 17, further comprising the step of receiving the fuel output from the second fluid outlet at the venturi pump reservoir.

19. The method recited in claim 14, wherein the urging step includes urging fuel from the venturi pump reservoir, the venturi pump reservoir being located within the fuel pump reservoir.

20. The method recited in claim 19, wherein the urging step includes drawing fuel in the venturi pump reservoir via a rigid tube extending into the venturi pump reservoir.
